(19) United States
(12) Patent Application Publication
(10) Pub. No.: US 2011/0069376 A1
(43) Pub. Date: Mar. 24, 2011

(54) FIBER MOPA WITH AMPLIFYING TRANSPORT FIBER

(75) Inventor: Andreas DIENING, Palo Alto, CA (US)

(73) Assignee: Coherent Inc., Santa Clara, CA (US)

(21) Appl. No.: 12/565,403

(22) Filed: Sep. 23, 2009

(51) Int. Cl. G02F 1/377; H01S 3/0941

(52) U.S. Cl. 359/329; 359/341.1; 359/341.32

(57) ABSTRACT

Frequency-multiplied fiber-MOPA apparatus includes one enclosure containing a master oscillator and fiber amplifier stages and another enclosure containing frequency-multiplying stages. Radiation is transmitted between the enclosures by a transport fiber in a flexible jacket or enclosure. The transport fiber functions additionally as a power amplifier fiber, and amplifies the radiation while transporting the radiation between the enclosures. The amplifying transport fiber is energized by diode-lasers in the enclosure containing the master oscillator and fiber amplifiers.

### TECHNICAL FIELD OF THE INVENTION

The present invention relates in general to master oscillator power amplifier (MOPA) laser systems including multiple fiber-amplifier stages. The invention relates in particular to pulsed fiber MOPA laser systems including one or more stages of frequency conversion.

### DISCUSSION OF BACKGROUND ART

Frequency converted fiber MOPAs are increasingly being used in applications where frequency-converted solid lasers were previously used. Such applications include micromachining/materials processing and wafer inspection. Fiber laser and fiber amplifier systems have certain advantages over solid state lasers. These advantages include more efficient use of pump power, permanence of alignment, and in many instances a convenience of packaging which is due to the fact that amplifier fibers can be coiled in an enclosure.

In a relatively low power frequency-converted MOPA system, for example having an average power for fundamental radiation of less than about 50-100 Watts (W), the master oscillator, fiber amplifier stages, diode-laser arrays for providing optical pump radiation, and one or two stages of harmonic conversion can usually be packaged in a single enclosure having a “footprint” of about 60 centimeters (cm)×20 cm. Power for powering the diode-lasers and other components can be supplied to the enclosure from a separate power supply, via a suitable cable and electrical connectors.

For a MOPA having higher average fundamental power, packing all MOPA and harmonic generating components in a single enclosure is impractical because of the heat-load created by less than 100% efficient pumping of the diode-lasers and MOPA components. One arrangement for packing such a MOPA is to package the power supply master oscillator and low power fiber amplifiers in a first enclosure, and to package a final power amplifier stage and harmonic generating stages in a second enclosure. A transport fiber arranged between the enclosures connects the amplified signal from the first enclosure to the power amplifier in the second enclosure. A diode-laser array for pumping the power amplifier can be located in the first or the second enclosure. If the diode-laser array for the power amplifier is in the first enclosure, a fiber will be required to transport pump radiation to the second enclosure. In either case, there will need to be an electrical connection between the enclosures as power will be required in the second enclosure for providing temperature control of the harmonic generating stages.

Amplifier fibers typically have a core diameter directly related to the peak power to be generated in the fiber. This is required to prevent the peak radiation intensity from reaching levels that could cause nonlinear optical effects, or even catastrophic optical damage. Certain types of amplifier fiber, such as PCF (photonic crystal fibers), used for such high power have low numerical aperture (NA) which makes them vulnerable to bending losses. Further, some photonic crystal fibers are not flexible and must be mounted in a rigid holder.

A large core diameter or a low numerical aperture will increase the minimum possible bending radius of an amplifier fiber to a level where it is not possible to package (coil) the amplifier fiber in an enclosure of the convenient dimensions possible in lower power MOPAs. There is a need for a method of packing a high-power fiber-amplifier in a MOPA that does not require scaling the dimensions of MOPA enclosures to accommodate the high-power fiber-amplifier.

### SUMMARY OF THE INVENTION

In one aspect of the present invention laser apparatus comprises an enclosure having a master oscillator located therein for generating signal radiation. One or more fiber amplifiers are located in the enclosure for amplifying the signal radiation. A transport fiber extends from the first enclosure. The transport fiber is arranged to further amplify the amplified signal radiation and transport the further-amplified signal radiation to either a device wherein the further-amplified radiation will be used, or a location where the further amplified radiation will be used.

In one preferred embodiment of the invention, the device is a harmonic-generator including one or more optically nonlinear crystals for frequency-multiplying the further-amplified radiation. The harmonic-generator is in another enclosure remote from that in which the master oscillator is located. The transport fiber can be selectively connected or disconnected from the enclosure in which the harmonic-generator is enclosed. The transport fiber is housed in a flexible jacket and is fluid-cooled. The amplifying transport fiber is energized (optically pumped) by diode-lasers in the enclosure in which the master oscillator is located.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a preferred embodiment of a fiber MOPA in accordance with the present invention, including a first enclosure housing a master oscillator, two stages of fiber-amplification and diode-lasers for providing pump radiation, the first enclosure being demountably connected by a water-cooled power amplifying fiber in a flexible housing to a second enclosure including one or more stages of harmonic conversion.

FIG. 2 schematically illustrates one arrangement of amplifiers and diode-lasers in the first enclosure of FIG. 1 including four diode-lasers delivering pump radiation to the water-cooled power amplifying fiber and an arrangement including re-circulating chiller for providing cooling water to the power-amplifier fiber.

FIG. 3 schematically illustrates one arrangement of harmonic conversion stages and a fiber connector for the amplifying fiber in the second enclosure of FIG. 1

### DETAILED DESCRIPTION OF THE INVENTION

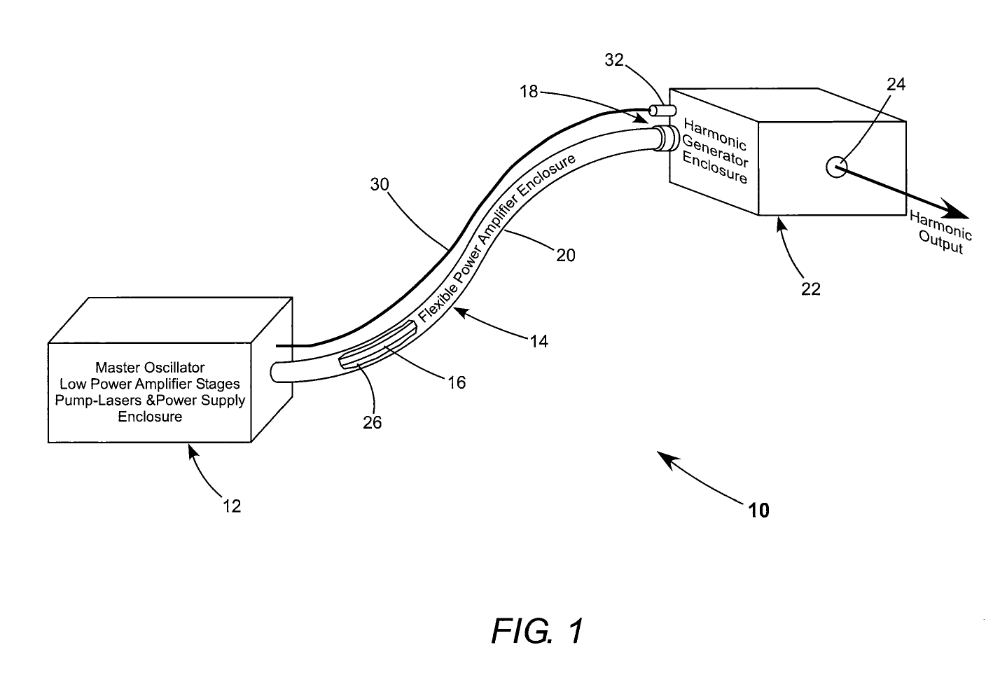

Referring now to the drawings, wherein like components are designated by like reference numerals, FIG. 1 schematically illustrates a fiber MOPA apparatus 10 in accordance with the present invention. MOPA 10 includes an enclosure 12 housing a master oscillator (MO), low power fiber amplifier stages, diode lasers for proving optical pump radiation for fiber amplifier stages and a power supply for providing power for the diode lasers and the master oscillator. Another enclosure 22 includes harmonic generation stages including optically nonlinear crystals. Pulses generated by the master oscillator in enclosure 12 and amplified by the low power fiber-amplifier stages in the enclosure are transported by a power-amplifier fiber 16 to enclosure 22 to be delivered to the harmonic generating stages. The harmonic radiation provided by the generators is delivered from enclosure 22 via a window 24 therein.

Power-amplifier fiber 16 receives pump-radiation for diode-lasers within enclosure 12. The power amplifier fiber is housed in a flexible jacket 20 and the fiber and jacket assembly (fiber assembly) 14 are connected by a connector arrangement 18 to enclosure 22. The connector arrangement allows the fiber assembly to be disconnected from enclosure 22, for example for convenience of transporting apparatus 10. The rigidity of the jacket is preferably selected such that assembly 14 can not be bent in a radius less than a bending-loss determined minimum bending radius for power-amplifier fiber 16.

An arrangement within enclosure 12 re-circulates cooling water (or some other fluid) through space 26 between power-amplifier 16 and jacket 20. An electrical lead 30 is connected by an electrical connector 32 to enclosure 22 and provides power from the power supply in enclosure 12 to thermo electric temperature controllers (TECs) for maintaining selected phase-matching temperatures for optically nonlinear crystals in enclosure 22. Although electrical lead 30 is depicted as being separate from fiber/jacket assembly 14 in FIG. 1, the lead can be integrated into assembly 14, for example, by winding the electrical lead helically around the jacket.

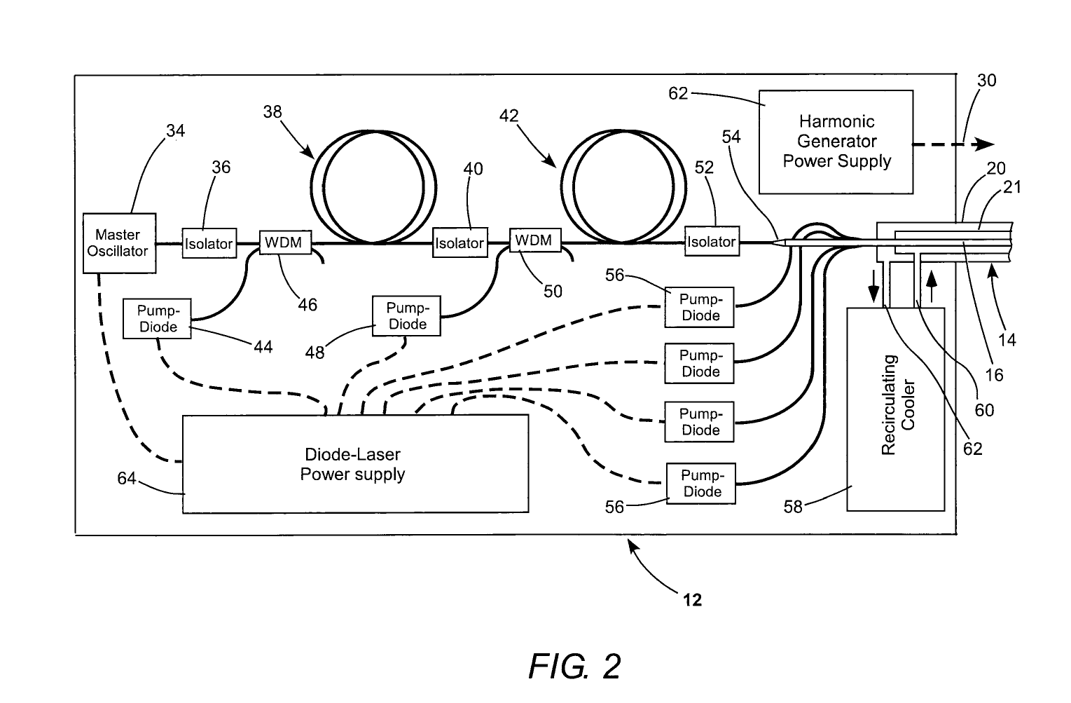

FIG. 2 schematically illustrates one example of an arrangement of amplifiers and diode-lasers in the enclosure 12 of apparatus 10 of FIG. 1. Here a master oscillator 34 in the form of a directly modulated diode-laser provides seed pulses of radiation to be amplified by the apparatus. The seed pulses can be generally defined as signal radiation. Optical fibers for low power amplification and for delivering pump radiation are designated by bold, solid lines. Electrical connections are designated by dashed, bold solid lines, to avoid confusion with lines designating optical fibers and lead lines of reference numerals.

Seed pulses (signal radiation) from master oscillator 34 are delivered via an isolator 36 to an amplifier-fiber 38 providing a first stage of amplification. Amplified pulses from fiber 38 are delivered via an isolator 40 to an amplifier-fiber 42 providing a second stage of amplification. Amplifier-fiber 38 is optically pumped by radiation from a diode-laser 44 fiber-coupled to fiber 38 via a wavelength division multiplex coupler 36. Amplifier-fiber 42 is optically pumped by radiation from a diode-laser 48 fiber-coupled to fiber 42 via a wavelength division multiplex coupler 50.

Twice-amplified pulses from amplifier-fiber 42 are delivered via an isolator 52 and a tapered coupler 54 to fiber 16. Fiber 16 may be a large-mode-area (LMA) fiber having a solid core and claddings or a photonic crystal fiber (PCF). In this example, pump-radiation from four diode-lasers 56 is fiber-coupled into cladding (not explicitly shown) via fibers fused-coupled to the cladding. A power supply 64 provides current for the pump diode-lasers and the master oscillator. A separate power supply 62 provides power via lead 30 to TECs in enclosure 22 as discussed above.

Fiber 16 is cooled by passing a cooling fluid, such as water, from a recirculating chiller (cooler) 58 via an input conduit 60 outward between an inner flexible jacket (tube) 21 and the fiber. The fluid returns between inner jacket 21 and outer jacket (tube) 20 then via an output conduit 62 to the chiller.

It should be noted that the subject invention is not intended to be limited to the any particular method of initially generating the laser pulses. For example, light from a CW laser diode can be externally modulated. In addition, a mode-locked laser can be used as a source of laser pulses. In the latter case, it may be desirable to include a pulse picker within enclosure 12 to reduce the repetition rate of the pulses to be amplified.

It should also be noted that some photonic crystal fibers are essentially rigid and would be supported in a rigid mount between the two enclosures.

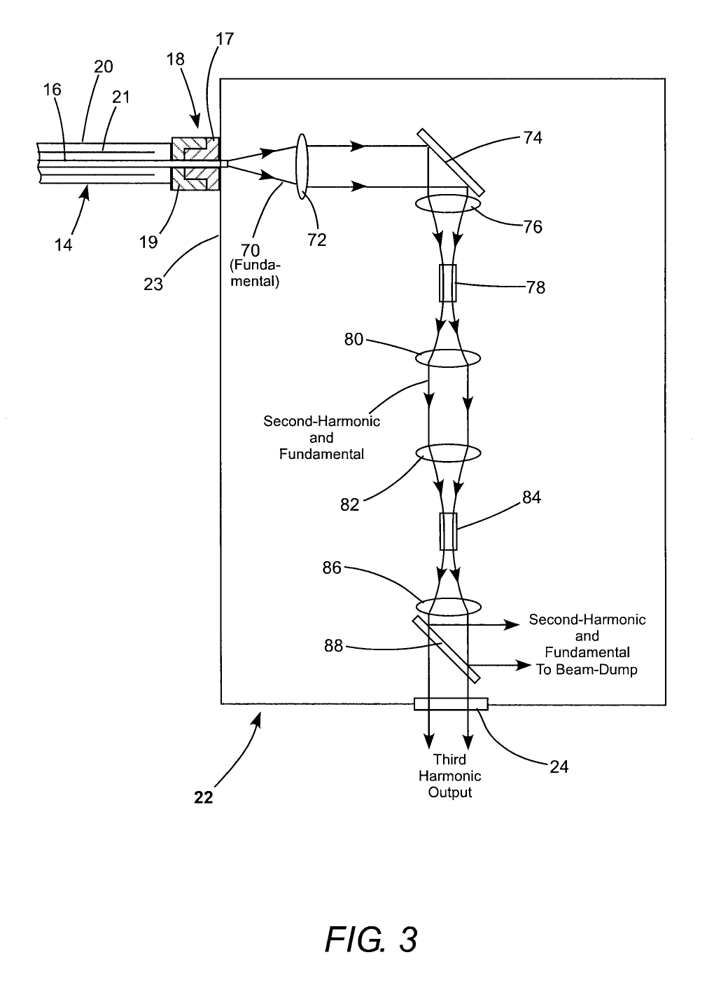

FIG. 3 schematically illustrates one arrangement of harmonic-conversion stages and fiber connector 18 in enclosure 22 of apparatus 10 of FIG. 1. Here fiber connector arrangement 18 includes a receiver member 17 which is attached to wall 23 of enclosure 22. A connector member 19 is attached to fiber assembly 14 and is removeably (demountably) coupled to receiver member 18, for connecting (or disconnecting) the fiber assembly from enclosure 22. Electrical connection to and within the enclosure and TECs within the enclosure are not shown in FIG. 3 for simplicity of illustration.

Fiber 16 delivers a diverging beam of radiation 70 into enclosure 22. The radiation has a fundamental wavelength of the master oscillator and amplifier fibers. Beam 70 is collimated by a lens 72 and directed by a turning mirror 74 to a lens 76. Lens 76 focuses the fundamental wavelength radiation to a beam waist in an optically nonlinear crystal 78 arranged to frequency-double the fundamental radiation to provide second-harmonic (2H) radiation. The 2H-radiation and residual fundamental radiation from the frequency-doubling process are collimated by a lens 80 then re-focused by a lens 82 into an optically nonlinear crystal 84 arranged to sum-frequency mix the 2H-radiation and residual fundamental radiation to provide third-harmonic (3H) radiation. The 3H-radiation and residual 2H and fundamental radiation from the sum-frequency mixing process are collimated by a lens 86. A dichroic beamsplitter 88 separates the residual 2H and fundamental radiation from the 3H radiation, and sent to a beam dump (not shown). The 3H-radiation is delivered from enclosure 22 via window 24 therein as output radiation.

It should be noted here that the harmonic conversion example described above is but one example of frequency conversion that can be carried out in the enclosure. More or less stages of conversion may be included for generating second or higher harmonic radiation. One or more crystals may by arranged for optical parametric generation wherein the fundamental wavelength radiation delivered from fiber 16 is frequency divided into parametric signal radiation and parametric idler radiation each having a wavelength longer than the wavelength of the fundamental wavelength radiation. These and any other frequency conversions may be carried out without departing from spirit and scope of the present invention.

Further it should be noted here that the multi-stage amplifier arrangement of enclosure 12 is one example provided to illustrate principles of the present invention and should not be construed as limiting. By way of example, more or less stages of low-power amplification may be included and different methods of coupling optical pump radiation to the amplifier fibers may be used. It is also possible to provide a separate power supply outside of the enclosure but electrically connected thereto. Different methods of circulating cooling fluid through fiber assembly 14 may also be used. It should also be noted that fiber assembly 14 may also be used simply to amplify and transport fundamental radiation from enclosure 22 to a location or device where, or in which, the radiation may be used. By way of example, one such device may be a device for scanning and focusing beam 70 for laser-drilling, laser-engraving or laser-machining operations.

In addition, while enclosure 22 is illustrated with optics for changing the frequency of the laser pulses, alternative laser pulse modification techniques can be employed in enclosure 22 other than (or in conjunction with) frequency conversion. For example, an additional amplifier stage or stages can be provided for further increasing the energy of the pulses. Alternatively, optics for changing the width of the pulse, such as stretchers or compressors, can be provided in enclosure 22. It should also be noted that the concept of using an amplifying transport fiber might also be of interest in continuous wave (CW) systems. One of the key advantages of the subject invention is that by combining the amplifying and transport functions into one fiber, the overall package size can be reduced in cases where the amplifying fiber is of the type that cannot be bent or has a limited bend radius. These and other variations of the present invention may be practiced without departing from the sprit and scope of the present invention as defined by the claims appended hereto.

What is claimed is:

1. Laser apparatus, comprising:
an enclosure;
a master oscillator located in a first enclosure for generating signal radiation;
one or more fiber amplifiers located in the first enclosure for amplifying the signal radiation; and
a transport fiber extending from the first enclosure, the transport fiber being arranged to further amplify the amplified signal radiation and deliver further amplified signal radiation to one of a device wherein the further amplified radiation will be used and a location where the further amplified signal radiation will be used.

2. The apparatus of claim 1, wherein the further amplified signal radiation is transported to the device.

3. The apparatus of claim 2, wherein the device is a frequency converter including one or more optically nonlinear crystals.

4. The apparatus of claim 3, wherein the frequency converter includes first and second optically nonlinear crystals, the first optically nonlinear crystal being arranged to generate second-harmonic radiation from the further amplified signal radiation, and the second optically nonlinear crystal being arranged to generate third-harmonic radiation by sum-frequency mixing the second-harmonic radiation with a portion of the further amplified signal radiation residual from the second-harmonic generation.

5. The apparatus of claim 1, wherein the transport fiber is located in a flexible jacket and means are provided for flowing a cooling fluid through the jacket for cooling the amplifying transport fiber.

6. The apparatus of claim 5, wherein the cooling fluid flowing means is a re-circulating chiller located in the first enclosure.

7. The apparatus of claim 5, wherein the cooling fluid is water.

8. The apparatus of claim 1, wherein the amplifying transport fiber is energized by radiation from a plurality of diode-lasers located in the first enclosure.

9. The apparatus of claim 8, wherein the radiation from the plurality diode-lasers is coupled to the amplifying transport fiber via a corresponding plurality of delivery fibers fused-coupled to cladding of the amplifying transport fiber at an end thereof located within the first enclosure.

10. The apparatus of claim 1, wherein the amplifying transport fiber is one of a large-mode-area fiber and a photonic crystal fiber.

11. Laser apparatus, comprising:
first and second enclosures;
a master oscillator located in a first enclosure for generating signal radiation;
one or more fiber amplifiers located in the first enclosure for amplifying the signal radiation; and
a transport fiber extending from the first enclosure, the transport fiber being arranged to further amplify the amplified signal radiation and deliver the further amplified signal radiation to an optical device located in the second enclosure, the amplifying transport fiber being demountably connected to the second enclosure.

12. The apparatus of claim 11, wherein the transport fiber is located in a jacket and means are provided for flowing a cooling fluid through the jacket for cooling the amplifying transport fiber.

13. The apparatus of claim 12, wherein the cooling fluid flowing means includes a re-circulating chiller located in the first enclosure.

14. The apparatus of claim 11, wherein the amplifying transport fiber is energized by radiation from a plurality of diode-lasers located in the first enclosure.

15. The apparatus of claim 14, wherein the radiation from the plurality diode-lasers is coupled to the amplifying transport fiber via a corresponding plurality of delivery fibers fused-coupled to cladding of the amplifying transport fiber at an end thereof located within the first enclosure.

16. The apparatus of claim 11, wherein said transport fiber is a photonic crystal fiber.

17. A laser system comprising:
a first enclosure, said first enclosure including a means for generating laser pulses;
a second enclosure for receiving said laser pulses, said second enclosure including means for modifying the pulses, wherein the modifying means functions to perform at least one of amplifying the laser pulses, changing the frequency of the laser pulses, and changing the length of the pulses; and
a fiber extending between said first and second enclosures, said fiber functioning to transport the laser pulses from the first enclosure to the second enclosure, said fiber further functioning to amplify the laser pulses.

18. A laser system as recited in claim 17, wherein said fiber is a photonic crystal fiber.

19. A laser system as recited in claim 18, wherein said photonic crystal is not flexible.
